(19) United States
(12) Patent Application Publication
(10) Pub. No.: US 2023/0392702 A1
(43) Pub. Date: Dec. 7, 2023

(54) SAFETY RELIEF PLUG WITH A FUSIBLE METAL AND RELATED DEVICES AND METHODS

(71) Applicant: ENTEGRIS, INC., Billerica, MA (US)

(72) Inventors: Christopher Brown, Toronto (CA); Martha Miller, Toronto (CA); Thomas M. Cameron, Newtown, CT (US)

(21) Appl. No.: 18/204,736

(22) Filed: Jun. 1, 2023

Related U.S. Application Data
(60) Provisional application No. 63/348,890, filed on Jun. 3, 2022.

(51) Int. Cl. F16K 17/38; B65D 51/16

(52) U.S. Cl. CPC F16K 17/383; B65D 51/1644

(57) ABSTRACT

Described are pressure relief devices and associated equipment, e.g., containers, the pressure relief device being adapted to provide pressure relief to a pressurized fluid within a container when a fusible metal component of the relieve device reaches a melting temperature.

### FIELD

The following description is in the field of devices, referred to as “plugs,” that include a fusible metal, and that are adapted to provide pressure relief for a storage container in the event of elevated temperature.

### BACKGROUND

Containers that are used to store or transport gas or liquid materials, sometimes at a condition of an elevated (greater than atmospheric) pressure, may be equipped with a device that opens the container interior to an exterior of the container in the event that the container is exposed to a dangerously high temperature, i.e., a “pressure-relief device.” When the container is exposed to a dangerously high temperature, the pressure-relief device creates an open flow path between the container interior and a contain exterior that allows contents at the container interior to be released, to prevent the interior from reaching an internal pressure that would cause the container to rupture, i.e., explode. A dangerously high interior pressure within the container may be caused by the container being located within a high temperature environment, such as due to a fire. In the event that a container is in the presence of a fire, the temperature of the container and of the pressure-relief device will increase, and when the device reaches a certain temperature the device creates an opening from the interior to the exterior, which allows the pressure at the container interior to be safely reduced to prevent an explosion. Several types of pressure-relief devices have been used to prevent excess pressure from building within a container, however there is a need to avoid contamination of contents of the container from leaching of materials of the relief devices.

### SUMMARY

Raw material gases and liquids that are provided to industry include products that are contained, stored, and transported in metal tanks that are built to contain the raw material liquid or gas, optionally under pressure. Many types of raw materials stored in these metal tanks are used in processes that require the raw material to be in a highly pure form. When the raw material is contained, stored, or transported in the metal tank, the tank should not introduce any new contaminant to the raw material.

Many metal tanks include a pressure-relief device in the form of a plug that contains a fusible metal such as tin, bismuth, lead, or cadmium. The fusible metal of the plug contacts the raw material contained in the tank and is a potential source of contamination, by leaching into the liquid or gaseous raw material contained in the tank.

The amount of fusible metal that may be added to the raw material by leaching may be very small, e.g., at a parts per million level or lower. But even this very low level of metal contaminant added to the raw material during storage or transport, from a metal storage tank, may cause a detrimental effect in certain processes that use the raw material. For example, various types of raw materials that are used in microelectronic and semiconductor manufacturing processes are used at very high purities. Some of these gaseous and liquid raw materials are stored and transported in metal tanks that contain pressure-relief devices that include a fusible metal. Examples of these types of raw materials are organometallic compounds, e.g., metal amides, metal alkyls (e.g., n-butyl lithium), and metal aryls. Other examples are silanes, such as halogenated silanes, e.g., chlorosilanes.

Metal (e.g., heavy metal) contaminants such as tin, bismuth, cadmium, lead, etc. if present in these types of raw material fluids can have a measurable detrimental effect on processes that use these materials for manufacturing semiconductor products, microelectronic devices, and the like. The presence of heavy metal contaminants such as bismuth or tin can affect the yield of a process, performance properties of devices prepared using the process, or both.

The disclosure relates to a thin coating of an inert barrier material at a surface of a fusible metal plug, to isolate the metal materials of the fusible metal plug (e.g., heavy metals) from a raw material contained in a container. The coating should be sufficiently thin to not prevent the fusible metal material from properly performing as a pressure-relief device, by melting and flowing at an elevated temperature to relieve pressure withing a container. Example coatings may be of chemically inert material such as a metal (e.g., nickel), metal oxide (Al or Y based), or perfluorocarbon (e.g., polytetrafluorethylene) and may be applied to the plug by a deposition technique such as chemical vapor deposition, physical deposition, atomic layer deposition, for metal oxides; electrodeposition for a metal; or by a coating technique such as dip coating, brush coating, spraying, or the like for a fluorocarbon coating.

In one aspect, the disclosure relates to a pressure-relief device in the form of a plug. The plug includes: a plug body; a flow path extending through the plug body between a first flow path end and a second flow path end; a fusible metal body contained in the flow path, the metal body comprising a first metal body end and a second metal body end; and a coating at a surface of the metal body at the first metal body end.

In another aspect, the disclosure relates to a container. The container includes a container wall, an enclosed container interior, and a plug. The plug includes a plug body; a flow path extending through the plug body between a first flow path end and a second flow path end; a fusible metal body contained in the flow path, the metal body comprising a first metal body end and a second metal body end; and a coating at a surface of the metal body at the first metal body end.

In yet another aspect, the disclosure relates to a method of preparing a plug. The plug includes; a plug body; a flow path extending through the plug body between a first flow path end and a second flow path end; a fusible metal body contained in the flow path, the metal body comprising a first metal body end and a second metal body end; and a coating at a surface of the metal body at the first metal body end. The method includes applying the coating to the surface at the first metal body end.

### BRIEF DESCRIPTION OF THE FIGURES

FIGS. 1A and 1B show an example pressure-relief device as described.

FIGS. 2A and 2B show an example pressure-relief device as described, as part of a fluid delivery valve.

The figures are not to scale.

### DETAILED DESCRIPTION

The following description relates to pressure-relief devices that are referred to as “plugs,” that include a plug body, a flow path within the plug body, and a fusible metal body that blocks the flow path. The fusible plug melts at elevated temperature and the flow path opens to allow fluid to flow through the flow path.

When the plug is installed as part of a container, the flow path extends between an interior of the container and an exterior of the container. In a state of normal use, the container, the plug, and the fusible metal body are at approximately ambient temperature, which is below a melting temperature of the fusible metal, which remains in solid form. The fusible metal body is positioned in the flow path, blocking the flow path and preventing fluid from flowing through the flow path of the plug.

At an elevated temperature, such as at a temperature that may occur during a fire, the fusible metal body that normally (at ambient temperature) blocks the flow path will melt and flow out of the flow path, causing the flow path to become open between the ends of the flow path. At the elevated temperature, a liquid fluid in the container becomes gaseous, and a gaseous fluid at high temperature creates a high internal pressure in the container. The opening of the flow path of the plug by the melting of the fusible metal body, at an elevated temperature, allows fluid (e.g., gas) to escape the interior and prevents the interior from becoming pressurized to a dangerous level, which could otherwise cause the container to explode.

The fusible metal body is made of a metal alloy that is “fusible,” meaning that the metal alloy “fuses” or melts at a relatively low temperature compared to many other metals and metal alloys. Examples of fusible metal bodies may be made from metals or metal alloys that include bismuth, tin, lead, cadmium, or a combination of these. As used herein, example fusible metal bodies can have a melting point that is below about 400 degrees Fahrenheit, e.g., a melting point in a range from 150 to 400 degrees Fahrenheit. Certain known fusible metal alloys are made with major parts of bismuth, tin, lead, and optional cadmium, in various combination and relative amounts, and have melting points of 165, 212, 283, and 300 degrees Fahrenheit.

In these types of pressure-relief devices, the fusible metal body of the plug is normally exposed directly to the gaseous or liquid contents at an interior of a container, and directly contacts the gaseous or liquid contents of the container. Some materials that are stored in these types of containers include materials that are used in processes that require a very high level of purity for the process and the raw materials used in the process. A container that is used to store and transport a raw material that must be used at a high purity level should not introduce any contaminant to the raw material.

As identified herein, metal materials that are used as a fusible metal as part of a pressure-relief device may potentially leach into a gas or liquid material that is stored or transported in a container that contains the pressure-relief device. The fusible metal may include tin, bismuth, lead, or other metal or heavy metal components. The fusible metal contacts the raw material at the container interior and is a potential source of contamination by any of the metal species, which may leach into the liquid or gas material, during contact.

The amount of fusible metal that may leach into the raw material as an added contaminant may be very small, e.g., at a parts per million level or lower. But even this very low level of metal contaminant added to certain types of raw materials can produce a detrimental effect in certain processes that use the raw material. For example, various types of raw materials that are used in microelectronic and semiconductor manufacturing processes are used at very high purities. Some of these gaseous and liquid raw materials are stored and transported in metal containers sometimes referred to as “tanks” or “pressure tanks,” that contain a pressure-relief device that includes a fusible metal that will allow contents of the tank to escape to prevent a pressure increase if the tank is exposed to a dangerously high temperature. Examples include organometallic compounds such as metal amides, metal alkyls (e.g., alkyl lithium compounds such as n-butyl lithium), and metal aryls (e.g., aryl lithium compounds), as well as silanes (e.g., halogenated silanes such as chlorinated silanes).

If these types of raw materials include heavy metal contaminants such as tin or bismuth, when used in semiconductor or microelectronic device processing, the contaminant can produce a measurable detrimental effect on the process. The presence of heavy metal contaminants such as bismuth or tin can affect the yield of a process or the performance of devices prepared using the process.

As described herein, a pressure-relief device (e.g., a “plug”) that includes a fusible metal body positioned within a flow path of the device also includes a coating over a surface of the fusible metal body. The coating is placed on a surface of the fusible metal body that will be exposed to an interior of a container and that will contact a gas or liquid material contained at the interior when the pressure-relief device is installed on the container filled with the gas or liquid material. The coating is adapted to prevent metal materials of the fusible metal body from being directly exposed to the interior of a container in which the plug is installed, and to prevent contact between the fusible metal body and contents of the container interior. The coating acts as a physical barrier between the fusible metal body and the contents of the container, to prevent the potential leaching of an amount of the fusible metal into the gaseous or liquid contents of the container, where any such metal material would be considered a contaminant.

The coating is a thin, chemically inert barrier layer that is placed over a surface of the fusible metal body of the plug to isolate the materials of the fusible metal body (which may be heavy metals such as tin, bismuth, or other metal or heavy metal species) from a gaseous or liquid material held at an interior of a container.

While the coating is effective as a barrier layer between the fusible metal body and the contents of the container, the coating is also designed to allow the fusible metal body to function as part of a pressure-relieve device. The fusible metal body, with the coating at a surface, should remain capable of being melted when exposed to a sufficiently high temperature and flowing out of the flow path of the plug to clear the flow path and allow gas or liquid at the container interior to escape from the container through the opened flow path, thereby avoiding a dangerous pressure build within the container.

The coating may be made from any material and may be applied by any method that forms the material of the coating into a barrier layer at a surface of the fusible metal body in a form that does not unduly affect the function of the fusible metal body, e.g., that does not prevent the fusible metal body from effectively flowing from the flow path when the fusible metal body melts at an elevated temperature, to clear the flow path.

Example materials of a coating include chemically-inert materials such as metal oxides (e.g., based on aluminum or yttrium), a metal (e.g., nickel) or a metal alloy, a fluorochemical such as a fluoropolymer or a perfluoropolymer (e.g., Teflon®).

Example coatings may be applied to the surface of the fusible body by any technique that can be used to form an effective coating as described. Useful techniques include deposition techniques such as chemical vapor deposition (and variants thereof, such as plasma-assisted chemical vapor deposition), atomic layer deposition, sputtering, and electrodeposition. Other useful techniques include coating techniques such as brush coating, spray coating, and dip coating. Useful techniques can be selected based on factors such as a desired thickness of a coating and a desired material of a coating. For depositing a pure metal such as nickel as a coating, a selected technique may be electrodeposition. For depositing an oxide such as alumina or yttria, a selected technique may be atomic layer deposition or chemical vapor deposition. For depositing a fluoropolymer, the fluoropolymer may be formed into a liquid by dissolving the fluoropolymer in solvent or by heating the fluoropolymer above a melting temperature, and the liquid can be applied to the surface by brush coating, dip coating, spray coating, or another useful coating technique.

The coating can have a thickness that causes the coating to be useful as a barrier layer that, when placed over a surface of a fusible metal body, inhibits or prevents an amount of metal of the fusible metal body from passing from the fusible metal body into a gaseous or liquid material that contacts the coating on a surface of a fusible metal body. The coating is also sufficiently thin and has mechanical properties that will not produce an undue detrimental effect on the function of the pressure-relief device to allow a pressure release from a container at an elevated temperature.

Example thicknesses of a coating can also depend on the type of coating and the process for applying the coating. As a general range, useful coatings may have a thickness in a range from 100 angstroms to 2 microns, such as from 500 angstroms to 1 micron.

A pressure-relief device may be in the form of a plug that includes a plug body that may be installed, e.g., as a plug to close and seal an opening in a sidewall structure of a container; as part of a fluid-dispensing valve; or as part of any other fluid control or fluid-handling device or equipment. The plug may include a plug body, a flow path that extends through the plug body, a fusible metal body within the flow path, and the coating on the surface of the fusible metal body.

The plug body can include a mechanical engagement that allows the plug body to be securely connected to a component of a container, flow control valve, conduit, etc. A useful mechanical engagement may be, for example, a threaded engagement between the container and the plug body, a flange, a compression fitting, a variable compression fitting, or a comparable mechanical structure that allows a secure engagement of the plug body with a container, valve, conduit (e.g., pipe), or another component of a container or flow control structure.

An example pressure-release device in the form of a plug includes a cylindrical plug body that includes a mechanical engagement at an outer surface of the plug body, and a flow path that extends along a length of the cylindrical plug body, through the plug body, from a first flow path end at one end of the cylindrical plug body to second flow path end at a second end of the cylindrical plug body. Located within the flow path, in a normal “plugged” state of use of the pressure-relief device, is a solid (at room temperature) fusible metal body that blocks the space of the flow path between the ends of the flow path and prevents the flow of any fluid through the flow path. The fusible metal body includes two ends, with one fusible metal body end being arranged toward the first end of the flow path and a second fusible metal body end being arranged toward the second end of the flow path. A coating is located at a surface of the fusible metal body at one of the two ends of the fusible metal body, particularly at an end that will be exposed to an interior of a container or flow control device.

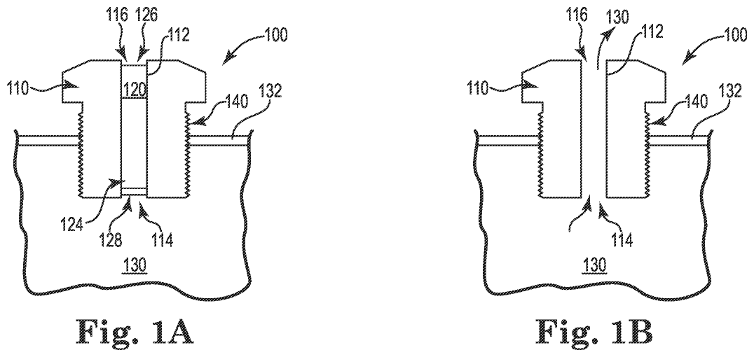

FIG. 1A shows an example of a pressure-relief device, i.e., a “plug,” as described, as part of a container that contains a liquid or a gas raw material in a highly purified form. Plug 100 includes cylindrical plug body 110 that includes flow path 112 having a first flow path end 114 and a second flow path end 116. Fusible metal body 120 is contained within flow path 112 and, with plug 100 in an ambient temperature condition, fusible metal body 120 is in a solid form that prevents flow of any fluid, 130, contained in container 132, through flow path 112. Also as illustrated, fusible metal body 120 includes a first fusible body end 124, which is oriented toward first flow path end 114, and a second fusible body end 126, which is oriented toward second flow path end 116. Located on the surface of the first fusible body end 124 is inert coating 128 as described. Mechanical engagement 140 at an exterior surface of plug body 110 engages a counterpart mechanical engagement surface of a sidewall of container 132; as illustrated, the mechanical engagements are opposed threaded engagements.

As illustrated at FIG. 1A, fusible metal body 120 is in a solid (un-melted) condition, and fills flow path 112 to prevent a flow of any of fluid 130 through plug body 110. Coating 128 is a coating as described herein that acts as a physical barrier between a surface of first fusible body end 124, and gas 130 at the interior of container 132.

As illustrated at FIG. 1B, container 132 and plug 100 are at an elevated temperature, such as a temperature in an atmosphere of a fire that would cause liquid contents of the container to vaporize, causing an increased internal container pressure. Fusible metal body 120 has melted and has flowed out of flow path 112, leaving flow path 112 open to allow gaseous fluid 130 to escape from the interior of container 132 through flow path 112. Allowing fluid 130 to escape the interior of container 132 prevents a pressure build that would otherwise occur by the temperature of fluid 130 being increased due to the fire, and prevents a catastrophic pressure failure and explosion of container 132 due to excess pressure at the interior.

As a different example of a pressure-relief device (e.g., a “plug”) as described, a plug may include a plug body that is part of a larger valve body that includes a fluid dispensing valve that is useful to dispense fluid from a container, while also housing the pressure-relief device. The fluid dispensing valve may be of any design, but can particularly be of a design useful to deliver a highly pure gaseous fluid from a container to processing equipment, such as to a deposition apparatus. The deposition apparatus may be one that is useful to perform atomic layer deposition, chemical vapor deposition, sputtering, or the like. The valve may include a valve body that connects to the container, a dispense port that can be connected to a piece of processing equipment, and the pressure-relief device (e.g., plug), which may be of a design that can be engaged and dis-engaged from the valve body.

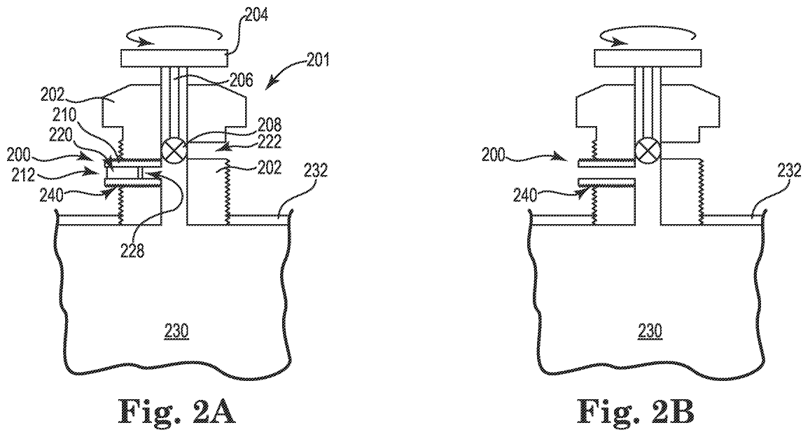

FIG. 2A shows an example of a pressure-relief device, i.e., a “plug,” as described, which is included in a larger valve device 201, which is installed at an outlet of a container that contains a liquid or a gas raw material in a highly purified form. Valve device 201 includes valve body 202, which includes a valve handle 204, valve stem 206, and valve actuator 208. Valve handle 204 can be turned to turn stem 206, which in response causes valve actuator 208 to move between an open position and a closed (as illustrated) position. In an open position, gas 230 can flow through valve body 202 and exit valve body 202 through dispense port 222, to be dispensed to a processing apparatus (not shown).

Valve device 201 includes plug 200, which is an example of a plug of the present description. As shown, plug 200 includes cylindrical plug body 210 that includes flow path 212, having two ends. Fusible metal body 220 is contained within flow path 212 and, with plug 200 in an ambient temperature condition, fusible metal body 220 is in a solid form that prevents flow of any fluid, 230, contained in container 232, through flow path 212. Fusible metal body 220 includes a first fusible body end oriented toward the first flow path end, and a second fusible body end that is oriented toward the second flow path end. Located on the surface of the first fusible body end is inert coating 228 (not to scale) as described. Mechanical engagement 240 at an exterior surface of plug body 210 engages a counterpart mechanical engagement surface of valve body 202; as illustrated, the mechanical engagements are opposed threaded engagements.

As illustrated at FIG. 2A, fusible metal body 220 is in a solid (un-melted) condition, and fills flow path 212 to prevent a flow of any of fluid 230 through plug body 210. Coating 228 is a coating as described herein that acts as a physical barrier between a surface of an end of fusible body 220 and gas 230 at the interior of container 232.

As illustrated at FIG. 2B, container 232 and plug 200 are at an elevated temperature, such as a temperature in an atmosphere of a fire that would cause liquid contents of the container to vaporize, causing an increased internal container pressure. Fusible metal body 220 has been melted and has flowed out of flow path 212, leaving flow path 212 open to allow gaseous fluid 230 to escape from the interior of container 232 through flow path 212. Allowing fluid 230 to escape the interior of container 232 prevents a pressure build that would otherwise occur by the temperature of fluid 230 being increased due to the fire, and prevents a catastrophic pressure failure and explosion of container 232 due to excess pressure at the interior.

A pressure-relief device as described may alternatively be included as part of a different type of container, valve, conduit (e.g., pipe), connecter, or any other flow control device or structure used to store, contain, or control a flow of a gaseous or liquid raw material. Examples include unions, half-unions, as well as other pipes, conduits, or connectors, pressure regulators, pressure-relief valves, among others.

A container that includes a pressure-relief device can be any type of container that may be used for storing, transporting, delivering, or handling a liquid or gaseous fluid, and that can incorporate the pressure-relief device for safety purposes. Generally, a container may be any type of enclosed vessel or conduit that includes an interior, that is used to contain or control a liquid or a gas either in a pressurized or non-pressurized condition. Examples include vessels that are sometimes referred to as cylinders, canisters, tanks, etc.

The container interior, at ambient temperature (e.g., at 23 degrees Celsius), may contain a liquid or gas, or both, at any pressure that the container is designed to accommodate. The interior pressure of the container may be below atmospheric pressure, above atmospheric pressure (e.g., at a pressure of up to or in excess of 20, 50, 100, 500, or 1000 pounds per square inch), or may be approximately equal to atmospheric pressure, for example in a range from 0.7 to 1.3 atmospheres pressure (absolute).

Example containers may be of a type that includes steel (e.g., carbon steel, stainless steel, etc.) sidewalls to contain a gas under pressure, and a valve or an outlet to which a dispense valve may be attached to allow the gaseous contents to be delivered from the container. The container may be of a type that includes welded seams, or that does not include any seams (i.e., is “seamless”).

A container may be of a standard or approved design, with examples being of a type that is useful to contain and transport propane for consumer sale. These may be rated to a “working pressure” of 260 pounds per square inch.

Example containers may meet certain specification of the US department of transportation, such as specified at DOT-4BW260, or, in Canada, TC-4BWM18.

Example containers can be of any useful interior volume, e.g., may have an interior volume of from 10 to 500 liters, such as from 20 or 50 liters up to 200, 300, or 400 liters.

A container may be designed to accommodate a highly pure fluid (liquid or gas) while minimizing the potential introduction of impurities to the fluid. These may be lined with a polymer or with an inert material such as a fluoropolymer, e.g., a perfluoropolymer such as polytetrafluoroethylene (e.g., Teflon®).

In a first aspect, disclosed herein is a plug comprising: a plug body; a flow path extending through the plug body between a first flow path end and a second flow path end; a fusible metal body contained in the flow path, the metal body comprising a first metal body end and a second metal body end; and a coating at a surface of the metal body at the first metal body end.

In a second aspect according to the first aspect, the coating comprises a metal, metal oxide, or fluoropolymer.

In a third aspect according to any preceding aspect, the fusible metal body has a melting point in a range from 150 to 400 degrees Fahrenheit.

In a fourth aspect according to any preceding aspect, at a temperature between 150 degrees and 400 degrees Fahrenheit the fusible metal body melts and flows from the flow path in a melted state to open the flow path between the first flow path end and the second flow path end.

In a fifth aspect according to any preceding aspect, the coating allows the fusible metal body to flow from the flow path in a melted liquid state path to open the flow path.

In a sixth aspect according to any preceding aspect, the fusible metal body comprises bismuth, tin, lead, cadmium, or a combination thereof.

In a seventh aspect according to any preceding aspect, the coating has a thickness in a range from 100 angstroms to 2 microns.

In an eighth aspect according to any preceding aspect, the plug body comprises an exterior surface that comprises an engagement selected from a threaded engagement, a flange, and compression fitting.

In a ninth aspect disclosed herein is a pressure-relief device comprising the plug of any preceding aspect.

In a tenth aspect according to the ninth aspect, the pressure-relief device is selected from the group consisting of a pressure-relief valve, conduit, connector, pressure regulator, pipe, conduit, connectors, union, and half-union.

In an eleventh aspect disclosed herein is a container comprising: a container wall; an enclosed container interior; and the plug of any of the first through eighth aspects.

In a twelfth aspect according to the eleventh aspect, the plug body engages the container at a sidewall.

In a thirteenth aspect according to the eleventh or twelfth aspect, wherein the plug body engages the container at pressure-relief device selected from the group consisting of a pressure-relief valve, conduit, connector, pressure regulator, pipe, conduit, connectors, union, and half-union.

In a fourteenth aspect according to any of the eleventh through thirteenth aspects, the coating is exposed to the container interior.

In a fifteenth aspect according to any of the eleventh through fourteenth aspects, further comprising an organometallic compound or a silane disposed in the container interior.

In a sixteenth aspect according to any of the eleventh through fifteenth aspects, further comprising a metal amide, a metal alkyl, or a metal aryl disposed in the container interior.

In a seventeenth aspect according to any of the eleventh through eighteenth aspects, further comprising organometallic alkyl lithium disposed in the container interior.

In an eighteenth aspect disclosed herein is method of preparing a plug comprising: disposing a fusible metal body in a flow path extending through a plug body between a first flow path end and a second flow path end, the metal body comprising a first metal body end and a second metal body end; and applying a coating at a surface of the metal body at the first metal body end.

In a nineteenth aspect according to an eighteenth aspect, the coating is applied to the surface by a deposition method selected from chemical vapor deposition, atomic layer deposition, physical vapor deposition, and electrodeposition.

In a twentieth aspect according to an eighteenth or nineteenth aspect, the coating is a metal oxide coating applied to the surface by chemical vapor deposition, physical vapor deposition, or atomic layer deposition.

In a twenty-first aspect according to an eighteenth or nineteenth aspect, the coating is a metal coating applied to the surface by electrodeposition.

In a twenty-second aspect according to an eighteenth or nineteenth aspect, the coating comprises a fluoropolymer and the coating is applied to the surface by a coating method selected from brush coating, spraying, and dip coating.

1. A plug comprising:
a plug body;
a flow path extending through the plug body between a first flow path end and a second flow path end;
a fusible metal body contained in the flow path, the metal body comprising a first metal body end and a second metal body end; and
a coating at a surface of the metal body at the first metal body end.

2. The plug of claim 1, wherein the coating comprises a metal, metal oxide, or fluoropolymer.

3. The plug of claim 1, wherein the fusible metal body has a melting point in a range from 150 to 400 degrees Fahrenheit.

4. The plug of claim 1, wherein at a temperature between 150 degrees and 400 degrees Fahrenheit the fusible metal body melts and flows from the flow path in a melted state to open the flow path between the first flow path end and the second flow path end.

5. The plug of claim 1, wherein the coating allows the fusible metal body to flow from the flow path in a melted liquid state path to open the flow path.

6. The plug of claim 1, wherein the fusible metal body comprises bismuth, tin, lead, cadmium, or a combination thereof.

7. The plug of claim 1, wherein the coating has a thickness in a range from 100 angstroms to 2 microns.

8. The plug of claim 1, wherein the plug body comprises an exterior surface that comprises an engagement selected from a threaded engagement, a flange, and compression fitting.

9. A pressure-relief device comprising the plug of claim 1.

10. The pressure-relief device of claim 9, wherein the pressure-relief device is selected from the group consisting of a pressure-relief valve, conduit, connector, pressure regulator, pipe, conduit, connectors, union, and half-union.

11. A container comprising:
a container wall;
an enclosed container interior; and
a plug comprising:
a plug body;
a flow path extending through the plug body between a first flow path end and a second flow path end;
a fusible metal body contained in the flow path, the metal body comprising a first metal body end and a second metal body end; and
a coating at a surface of the metal body at the first metal body end.

12. The container of claim 11, wherein the plug body engages the container at a sidewall.

13. The container of claim 11, wherein the plug body engages the container at pressure-relief device selected from the group consisting of a pressure-relief valve, conduit, connector, pressure regulator, pipe, conduit, connectors, union, and half-union.

14. The container of claim 11, wherein the coating is exposed to the container interior.

15. The container of claim 11, further comprising an organometallic compound or a silane disposed in the container interior.

16. The container of claim 11, further comprising a metal amide, a metal alkyl, or a metal aryl disposed in the container interior.

17. The container of claim 11, further comprising organometallic alkyl lithium disposed in the container interior.

18. A method of preparing a plug comprising:
disposing a fusible metal body in a flow path extending through a plug body between a first flow path end and a second flow path end, the metal body comprising a first metal body end and a second metal body end; and
applying a coating at a surface of the metal body at the first metal body end.

19. The method of claim 18, wherein the coating is applied to the surface by a deposition method selected from chemical vapor deposition, atomic layer deposition, physical vapor deposition, and electrodeposition.

20. The method of claim 18, wherein the coating is a metal oxide coating applied to the surface by chemical vapor deposition, physical vapor deposition, or atomic layer deposition.

21. The method of claim 18, wherein the coating is a metal coating applied to the surface by electrodeposition.

22. The method of claim 18, wherein the coating comprises a fluoropolymer and the coating is applied to the surface by a coating method selected from brush coating, spraying, and dip coating.
